(19) United States
(12) Patent Application Publication
(10) Pub. No.: US 2018/0291656 A1
(43) Pub. Date: Oct. 11, 2018

(54) LATCHING DEVICE FOR A MOTOR VEHICLE

(71) Applicant: Kiekert AG, Heiligenhaus (DE)

(72) Inventor: Robert J. Hunt, Davisburg, MI (US)

(21) Appl. No.: 15/481,037

(22) Filed: Apr. 6, 2017

(51) Int. Cl. E05B 83/18; E05B 15/16; E05B 77/36

(52) U.S. Cl. CPC E05B 83/18; E05B 77/36; E05B 15/1635

(57) ABSTRACT

A latching device (1) for a motor vehicle, having a locking mechanism (5, 6) consisting of a catch (5) and at least one pawl (6), a switching element (8), in particular a microswitch (8), whereby a position of the catch (5) can be ascertained by means of the switching element (8), and an operating element (4) for the switching element (8) arranged between the catch (5) and the switching element (8), whereby the operating element (4) is executed at least partially as a flexible operating element (4).

The invention relates to a latching device for a motor vehicle, having a locking mechanism comprising a catch and at least a pawl, a switching element, in particular a microswitch, whereby a position of the catch can be determined by means of the switching element and an operating element for the switching element arranged between the catch and the switching element.

### BACKGROUND

In order to also attain maximum safety in the motor vehicle, safety-related components and/or their function are preferably monitored. It is known, for example, that the latching of a motor vehicle door or flap is monitored by means of a switching element. Consequently, information is available regarding whether the door or flap is completely locked. The latching devices in paticular has a locking mechanism comprising a catch and at least one pawl, whereby the proper engagement of the locking mechanism components constitutes a safety-related characteristic in the motor vehicle which is verifiable usually directly with a switching element. In contemporary vehicles, for example, a warning light illuminates as soon as not all doors and/or flaps are completely closed on start-up.

In a latching device of such a motor vehicle, it is known to provide a switching element in the form of sensors and/or switches which interact with the catch and/or pawl. These components have a perimeter which can interact with the sensor. It is also known to not execute the contact between the catch and the sensor or pawl and sensor directly but via an operating element in order to also be able to arrange a sensor further away from the catch or pawl.

DE 10 2007 056 251 A1 reveals an arrangement in a latching device of a motor vehicle which comprises at least a catch and a pawl and at least one sensor for determination of a position of the catch and pawl to one another in which a contour lever is provided for which interacts with the catch and the pawl on the one hand and at least one sensor on the other hand. The contour lever in this class-specific state of the art is pivotably incorporated in the latching device, whereby the pawl interacts with a protruding profile on the contour lever. A movement of the pawl initiates a pivoting movement of the contour lever which interacts with a switching element with an end of the contour lever opposing the profile.

From DE 199 44 407 A1, an electrical latch is known whereby an electrical latch is understood to mean a latch or a latching device in which the locking mechanism can be electrically unlocked. The pawl is disengaged by means of an opening lever to this end. Consequently, the catch becomes free and the latching device can release a latch holder. The pawl encompasses a lever arm which has an extension which interacts with a lever element of a microswitch in turn. According to the position of the pawl and the lever arm arranged on the pawl, the latching device can thus be closed directly onto the position of the pawl.

The class-specific state of the art according to DE 10 2007 056 251 A1 and also the aforementioned documents outside of the class encounter limits if, with further requirements on the latching devices, less installation space is available and a structurally cost-effective solution is required to operate a switching element. This is where the invention is used.

### SUMMARY

The invention is based on the technical problem of improving such a latching device for a motor vehicle, in particular to improve it to the extent that a design of an operating element for a switching element as space-saving and as structurally cost-effective as possible is provided.

The task is solved according to the invention by the characteristics of the independent patent claim. Advantageous designs of the invention are specified in the sub-claims. It is to be noted that the design examples described hereafter are not restrictive; instead, any variations are possible of the characteristics described in the description and the sub-claims.

According to the invention, this technical problem is solved by providing a latching device for a motor vehicle, having a locking mechanism comprising a catch and at least a pawl, a switching element, in particular a microswitch, whereby a position of the catch can be determined by means of the switching element and an operating element for the switching element arranged between the catch and the switching element, whereby the operating element can be executed as a flexible operating element The design of the operating element according to the invention now creates the possibility of adapting the operating element to the structural specifications of the latching device. In fact, the operating element can be mounted in a position on a locking mechanism component necessary for advantageous construction, whereas the switching element can be positioned independently thereof in a position for favorable electrical contact. The design of the operating element as a flexible component even gives the possibility of arranging the operating element in an area unaccessible for a rigid component. This structural advantage means that the operating element can be arranged in a structurally favorable manner and the operating element itself can be designed in such a way that the latching device can have the smallest possible construction.

Different latches can be used as latching devices or motor vehicle latches. The latching device can be used as a compact constructional unit, for example in a lateral door, a sliding door or in the vicinity of flaps or lids or covers.

A locking mechanism in a latching device has a catch and at least one pawl, whereby the catch can be held in a locked position using the pawl. Two-stage locking mechanisms with a pre-ratchet and a main ratchet are used, as are systems with one or two pawls.

A triggering lever acts on the locking mechanism, whereby the triggering lever disengages one or several pawls with the catch, by a pivoting movement, for example. The triggering lever is pivotably accommodated in the latching device and preferably in a housing and/or a latch case of the motor vehicle latch. Such latching systems are also previously known from the class-specific state of the art.

Microswitches preferably act as switching elements. However, the invention is not limited to mechanical switching elements, but contactless switching elements can also be used. It is crucial for the invention that by means of the switching element a position of the catch and/or a position of the locking mechanism can be detected. The locking mechanism can be in an opening position, whereby an infeed section of the catch is aligned for interaction with a latch holder. The catch can be transferred into a pre-ratchet position and/or a main ratchet position by means of the latch holder or a movement of the latching device. As a safety-related component in the motor vehicle it is crucial that the locking mechanism engages in a main ratchet position in order to guarantee secure latching of the latching device. It is preferably queried via the position of the catch whether the catch is in a locked position. The position of the pawl can also be queried. Consequently, both the position of the catch and the position of the pawl can be queried and determined by means of a switching element.

An operating element arranged on the catch interacts with the switching element, whereby the interaction in designed in such a way that the switching element is operated by means of the operating element in order to determine an opening position of the catch, for example. If the operating element is designed as a flexible operating element, the operating element can thus also be mounted in difficult-to-access areas of the latching device, whereby a high degree of structural freedom is attained for the latching device.

In one design variant of the invention, the operating element can be executed as a separate component. The design of a separate component can facilitate mounting of the operating element. In particular, the flexible area of the operating element and the design as a separate component can facilitate mounting to the extent that the flexibility is useful for mounting. The operating element can be mounted on the catch, for example, and can be added onto a catch contour, for example. It is therefore not mandatory for mounting to align the catch in relation to the operating element. In addition to the mounting advantage, the separate execution of the operating element also offers a manufacturing advantage as it increases the structural freedom for manufacture of the operating element.

If the operating element is made of plastic, at least in places, a further advantageous design form of the invention results. In particular, flexibility can be attained by a plastic component cost-effectively and with low manufacturing costs. If, for example, at least the flexible area of the operating element is made of plastic, it can flexibly be adapted to the structural condition in the latching device. Hereby it is also conceivable that the operating element is formed solely partly from plastic and also a metallic material. This also offers the advantage in particular that a sensor reacting to metals is used, for example, by means of the metallic area of the operating element. The use of metallic areas on the operating element also gives the advantage of low wear being anticipated.

In a further design form of the invention, an advantage results if the operating element has at least a first flexible area and at least a second rigid area. The possibility of formation of a first flexible area enables connection of the operating element to areas, for example, of the catch which offer a favorable connection for the operating element and which are only attainable due to a flexibility of the operating element. From the combination of flexibility and the immobile or rigid area a sliding element can be provided. Consequently, safe accommodation or guidance of the operating element can be guaranteed and a high degree of structural freedom of the connection of the operating element is guaranteed.

The design form of the operating element as a sliding element offers the advantage that safe contacting of the switching element can be guaranteed and furthermore safe contact can be attained with the lowest possible spatial requirements. In contrast to pivotably arranged levers, a sliding element only requires a guide which can be provided, for example, by a housing of the latching device. Advantageously, the operating element can be incorporated in the housing of the latching device in a form-fitting manner.

It can thus be advantageous if the rigid area of the operating element can be engaged with the switching element. The design of the operating element with at least a rigidly designed area in places can enable safe operation of the switching element. The latching device must be durable in all functions over its lifetime. To this end, a rigid, and for example, at least a rigid area of the operating element made of a metallic material at least in places can guarantee functional safety. The rigid area thus ensures functional safety and at the same time it can be guided in a positionally stable manner in relation to the switching element.

If the operating element can be connected with the catch in a form-fitting manner, a further design variant of the invention results. A form-fitting connection between the operating element and the catch offers both the advantage of easy connectivity between the operating element and the catch and the advantage that a high degree of positional stability can be attained for the operating element. If, for example, a cylindrical elevation is present on the catch, such as a pin, thus a ring element arranged at one end of the operating element can be mounted on the pin. Such a form-fitting connection between the operating element and the catch can, according to the tolerance of the connection, attain low-play positioning of the operating element. Furthermore, the operating element can also be inserted into a recess of the catch or the catch sheathing in a form-fitting manner.

The latching device can also incorporate an operating element which has a rectangular shape in the flexible area, in particular a flat shape. The operating element is preferably made of plastic and in particular of flexible plastic in the flexible area. If this flexible area of the operating element is now designed in the form of a ribbon cable or a flat and rectangular area, the operating element can thus be bent beyond the flat shape.

A flat and rectangular shape offers a high degree of stability in relation to the positioning of the operating element and simultaneously the possibility of guiding the operating element with a high degree of freedom of movement along a guide of the catch, for example. The flat area of the operating element can be adjacent to the guide, so that a support can also be formed for the operating element. In fact, the catch has an element for guiding the operating element, whereby the operating element becomes two-dimensionally adjacent on the guiding element. This guarantees a high degree of functional safety and in particular safe guidance of the operating element in the latching device can be guaranteed.

Advantageously, the catch haves a guiding element for the operating element, at least in places. The operating element can be engaged with the catch in such a way that the operating element follows a movement of the catch. The operating element can be mounted in the catch in such a way that a sufficient path is available to operate the switching element. The catch accomplishes a pivoting movement, whereby the mounting point of the operating element accomplishes a circular movement on the catch. In order to attain safe operation and positioning of the operating element, the operating element must be able to be guided safely. By means of the guiding element, the operating element and in particular the flexible area of the operating element can thus become adjacent to the guiding element, whereby safe movement or actuation of the operating element can be guaranteed. The guiding element is preferably formed as a guiding rib protruding from the catch.

If the operating element can be guided at least partly in a housing of the latching device, a further design variant of the invention thus results. The catch is pivotably accommodated in the housing of the latching device and accommodated in a latch plate of the latching device, at least on one side. The catch is thus surrounded at least on one side by a housing base or a housing lid. If the operating element is now connected to the catch, there is the possibility of inserting a guide into the housing, so that the operating element can be safely guided along its movement or along its traveling distance. Furthermore, the operating element can also be guided in a housing base, for example. Consequently, easy mounting of the operating element can be attained.

Advantageously, the switching element can be arranged in the area of a contact element of the latching device according to the invention. By using an operating element which is movably arranged in the housing or in the latching device, the movement of the catch can be transferred to an area in the latching device which is also at a great distance. This can be used advantageously to the extent that the electrical contacts can be arranged for the switching element directly in an area of a contact element, for example a plug connection. The manufacturing costs are reduced as a result and a high degree of structural freedom results in the development of the latching device.

If the operating element has a contour adjustable to the switching element in the engagement area of the switching element, in particular a bevel, safe operation of the switching element is thus enabled. Due to a formation of a contour adjustable to the tappet of the switching element, the switching time of the switching element can be determined very accurately and simultaneously an easy, low-noise and safe activation of the switching element can be attained over the lifetime. The end of the operating element which engages with the switching element can, for example, have a beveled contour. Consequently, the engagement of operating elements and switching elements can be safely operated by a rising flank of the contour. The construction of the operating element according to the invention enables a high degree of functional safety and a high degree of structural freedom to be attained in the configuration and development of the latching device.

The invention is described in further detail below with reference to the attached sketches on the basis of a preferred design example. However, the principle applies that the design example does not limit the invention, but only constitutes an advantageous execution form. The characteristics depicted can be executed individually or in combination, individually or in combination with other characteristics of the description, as also the patent claims.

### BRIEF DESCRIPTION OF THE DRAWINGS

The following are shown:

FIG. 1 a top view of a latching device designed according to the invention, whereby a housing lid of the latching device is reproduced transparently, so that the position of the operating element is recognizable in reference to the catch and switching element, the position of the catch is reproduced, in which the operating element is engaged with the switching element,

FIG. 2 a top view of the latching device according to FIG. 1, whereby the locking mechanism and in particular the catch is reproduced in a main ratchet position, and the operating element is disengaged from the switching element; and

FIG. 3 a detailed view on the operating element, whereby the interplay between the operating element and guide in the housing is reproduced.

### DETAILED DESCRIPTION

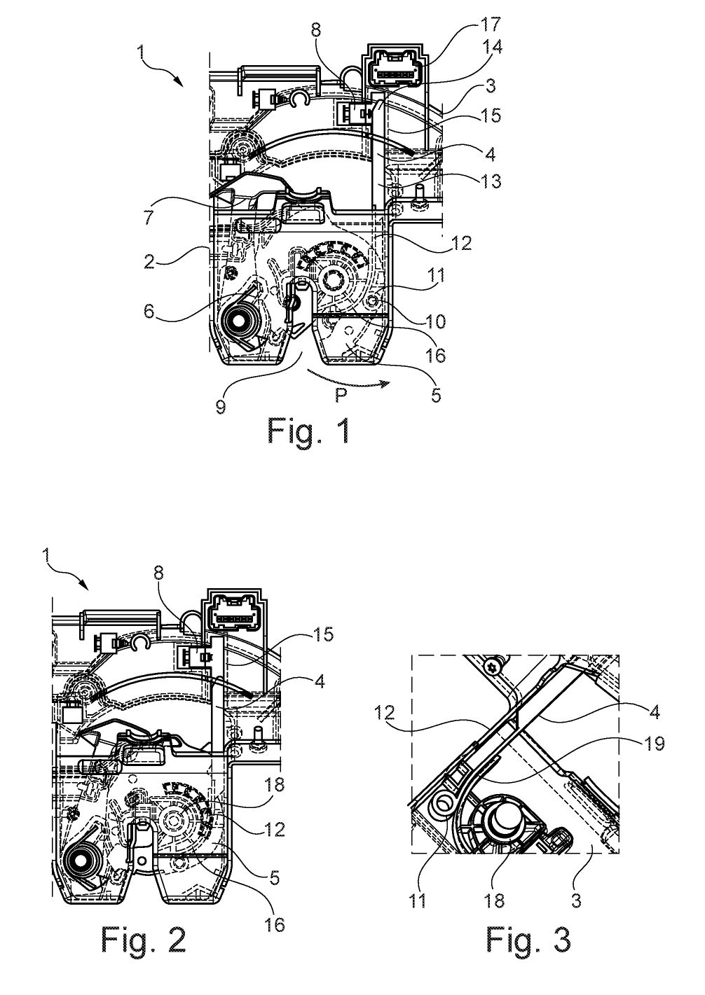

In FIG. 1, a latching device 1 is reproduced in a top view and in the form of a tailgate latch. The latching device has a latch plate 2, a housing 3, an operating element 4, a catch 5, a pawl 6, a triggering lever 7 and a number of micro-switches 8. The latching device 1 is reproduced in a position in which the locking mechanism 5, 6 is in an unlocked position, whereby the catch 5 is depicted in an end position, having been pivoted in the direction of the arrow P. for the manner of the interplay between the catch and the pawl is known from the state of the art. In the present case, the catch is in a position in which the locking mechanism 5, 6 is unlocked and the catch is open. A switching lever can now be inserted into an infeed section 9 and move the catch in a clockwise direction contrary to the direction of the arrow P.

The illustrated position shows the open position of the catch 5 in its end position. The operating element 4 is connected to the catch in a form-fitting manner. In particular, the catch has a cylindrical pin 10 which, for example, is formed integrally with a catch sheathing and via which a connector 11 of the operating element 4 is joined. The connecting element 11 is part of an operating element 4 and integrally formed with the operating element 4 for example as a plastic component. A form-fitting connection is thus illustrated between the catch 5 and the operating element 4. A first flexible area 12 of the operating element 4 is connected to the connecting element 11. A second rigid area 13 of the operating element 4 is connected to the flexible area 12 in turn. In fact, the connecting element 11, the flexible area 12 and the rigid area 13 are formed integrally and, for example, as a plastic component. At one end of the operating element 4 the rigid area 13 has a contour 14 which can be engaged with the switching element 8.

As illustrated in FIG. 1, the catch 5 is in an end position deflected in the direction of the arrow. Consequently, maximum pivoting of the catch 5 is reproduced in an anti-clockwise direction. In this case, the operating element 4 was moved by means of the catch and in particular by means of the pin 10 of the catch in such a way that the operating element 4 was engaged with the microswitch 8. The operating element 4 can be moved in guides 15 of the housing 3 for example. The guide 15 enables the rigid area 13 to only be moved in the direction of the microswitch 8. Operation of the switching element 8 which is thus accurate and with a high degree of functional safety can be enabled by means of the operating element 4. As can be ascertained in FIG. 1 below, the switching element 8 is arranged in close proximity to a contact element 17, for example a plug contact. Due to the close proximity to the contact element 17 the latching device 1 gives the possibility of minimizing the electrical conductors for contact of the switching elements 8, whereby the configuration of the electrical wires is considerably simplified in the latching device 1.

Even if in FIG. 1 a combination of flexible area 12 and rigid area 13 is reproduced, it is thus also possible to equip the operating element with more than one flexible area, for example two or three flexible areas. Consequently, contacting of a switching element 8 can also be enabled in a difficult-to-access area of the latching device 1.

FIG. 2 shows the latching device 1 in a position in which the catch 5 is reproduced in its main ratchet position. The position of the operating element 4 is clearly recognized, whereby the operating element 4 was pushed along the guide 15. Consequently, the operating element 4 is disengaged from the switching element 8. It is also clearly apparent that the flexible area 12 of the operating element 4 joins the guide 16 and can be guided by means of the guiding element 16 and thus by means of the catch. Advantageously, flexible areas 12 and rigid areas 13 complement one another, whereby the flexible area 12 can enable both pivoting or movement of the pin 10 on a circuit around a rotational axis 18 of the catch 5, whereby the flexible area 12 is elastically deformed and the rigid area 13 enables safe guidance and operation in the area of the switching element 8.

In FIG. 3 the operating element 4 is detached from the catch 5 and reproduced in reference to a position to the housing 3. It is apparent that the operating element is also guided in the flexible area 12 by means of a guide 19 in the housing 3. Safe guidance of the operating element 4 is thus also guaranteed in the flexible area 12 of the operating element 4 in the latching device 1. Consequently, the operating element 4 is safely guided via a guiding element 11, the guide 15, 19 in the housing 3 of the latching device. In particular, the formation of a flexible area 12 of the operating element 4 can thus attain a high degree of design freedom in the position of the switching element 8 in the latching device 1.

### REFERENCE SIGN LIST

1 Latching device
2 Latch plate
3 Housing
4 Operating element
5 Catch
6 Pawl
7 Triggering lever
8 Microswitch, switching element
9 Infeed section
10 Pin
11 Connecting element
12 Flexible area
13 Rigid area
14 Contour
15, 19 Guide
16 Guiding element
17 Contact element
18 Rotational axis
18 P Arrow

1. A latching device for a motor vehicle, having a locking mechanism consisting of a catch and at least a pawl, a switching element, in particular a microswitch, whereby a position of the catch can be ascertained by means of the switching element, and an operating element for the switching element arranged between the catch and the switching element, wherein the operating element is executed at least partially as a flexible operating element.

2. The latching device according to claim 1, wherein the operating element is executed as a separate component.

3. The latching device according to claim 1, wherein the operating element is made at least partially of plastic.

4. The latching device according to claim 1, wherein the operating element has at least a first flexible area and at least a second rigid area.

5. The latching device according to claim 4, wherein the rigid area of the operating element can be engaged with the switching element.

6. The latching device according to claim 4, wherein the flexible area of the operating element has a rectangular shape, in particular a flat shape.

7. The latching device according to claim 1, wherein the operating element can be connected to the catch in a form-fitting manner.

8. The latching device according to claim 1, characterized in that wherein the catch has a guiding element at for the operating element at least in places.

9. The latching device according to claim 1, wherein the operating element can be guided at least in places in a housing of the latching device.

10. The latching device according to claim 1, wherein the switching element is arranged in the area of the contact element of the latching device.
